(19) United States
(12) Patent Application Publication
(10) Pub. No.: US 2025/0169494 A1
(43) Pub. Date: May 29, 2025

(54) Composition with Residual Anti-Microbial Activity

(71) Applicant: ARXADA AG, Visp (CH)

(72) Inventors: David Binder, Saddle Brook (NJ); Xiao Jiang, Morristown, NJ (US); Lehong Jin, Huntersville, NC (US); Mikhail Motornov, Clark, NJ (US)

(21) Appl. No.: 18/834,269

(22) PCT Filed: Feb. 28, 2023
(86) PCT No.: PCT/US2023/014112

§ 371 Date: Jul. 30, 2024

Related U.S. Application Data
(60) Provisional application No. 63/325,823, filed on Mar. 31, 2022.

(51) Int. Cl. A01N 33/12; A01N 25/10; A01P 1/00

(52) U.S. Cl. CPC A01N 33/12; A01N 25/10; A01P 1/00

(57) ABSTRACT

The present disclosure is directed to a disinfectant composition that includes a quaternary ammonium biocide in combination with a polyethyleneimine film forming agent. The disinfectant composition forms a film on a surface that is abrasion resistant and that provides anti-microbial activity over an extended period of time.

### BACKGROUND

Pathogenic organisms, such as bacteria, fungi, and viruses, continue to cause infections in humans as well as domestic animals and pets. Disinfectant formulations have been developed over the last several decades to reduce or destroy pathogenic organisms and accordingly, reduce the rate of infection. There has been a particular focus on hard surfaces, including floors, walls, countertops, windows, windowsills, sinks, faucets, waste containers, appliances, and cabinet surfaces, as any hard surface can become contaminated. Disinfectants have been developed to treat hard surfaces for use in hospitals, rest homes, schools, and homes, however, existing disinfectant compositions fail to provide adequate residual antimicrobial activity between cleanings and therefore require repeated sanitization or reapplication of the disinfectant composition. Namely, the efficacy of many disinfectant compositions rapidly decreases after application. In particular, existing disinfectant compositions fail to remain on the surface for any length of time to provide sustained efficacy, as the disinfectant composition rapidly degrades, evaporates, or tends to be physically removed from the surface due to repeated touching or wiping with a cloth. As a result, if the surface becomes re-contaminated, the disinfectant composition must be reapplied in order to kill the newly deposited microorganisms. As such, many existing disinfectant compositions are unable to maintain their anti-microbial properties on high wear surfaces, and are easily removed by abrasion or frequent touching.

For instance, a particular class of antimicrobial compositions includes quaternary ammonium compounds, also known as “quats”, as a microbial control agent. The use of quats as biocides is well known, however, disinfectant compositions containing quaternary ammonium compounds fail to provide prolonged anti-microbial activity. Furthermore, most cationic formulations, such as quat-based wipe disinfectant formulations, leave significant residues that are particularly noticeable on smooth glossy surfaces, while also failing to provide prolonged anti-microbial protection to high touch or high friction surfaces.

Efforts to form disinfectant compositions having long-lasting anti-microbial effects have included imbedding biocidal metals on various surfaces. Unfortunately, such compositions are costly, and require concentrations above the regulatory limits for many areas to provide sufficient anti-microbial effect.

Therefore, it would be a benefit to provide a disinfectant composition that exhibits good anti-microbial effect over a prolonged period of time. It would also be a benefit to provide a disinfectant composition that provides an anti-microbial effect over a period of time even in frequent touch or high abrasion surfaces. It would also be a benefit to provide one or more of the above benefits using a disinfectant composition that is substantially free of biocidal metals.

### SUMMARY

In general, the present disclosure is directed to a disinfectant composition that provides hard surfaces with residual anti-microbial activity. The disinfectant composition includes a quaternary ammonium biocide and a film forming agent, where the film forming agent includes a polyethyleneimine. Furthermore, the composition provides a Log Reduction of about 2 or greater against S. aureus after undergoing abrasion resistance testing according to EPA 01-1A.

In one aspect, the disinfectant composition has a basic pH, such as about 9 or greater, or even about 9.5 or greater. Furthermore, in an aspect, the disinfectant composition can include a nonionic surfactant, a toughing agent, which can be, in one aspect, a toughening surfactant, or a combination thereof. In yet another aspect, the toughening agent is a C12 to C24 fatty alkyl quaternary ammonium compound or a silane quaternary ammonium that is different from the quaternary ammonium biocide. Additionally or alternatively, in an aspect, the toughening agent is a cetyl trimethyl ammonium compound, a lauryl trimethyl ammonium compound, a stearyldimethyl benzyl ammonium compound, a soyatrimethylammonium compound, a behentrimethylammonium compound, a dimethyl ditallow quaternary ammonium compound, or a combination thereof. In one aspect, the nonionic surfactant is an alkyl polyglucoside, an alcohol polyglycol ether, an amine ethoxylate, a fatty alcohol alkoxylate, a polyethylene glycol (PEG), an alcohol PEG-ether, a fatty acid ethoxylate, a glycerol ester, or combinations thereof, and is an alkyl polyglucoside in one aspect.

Furthermore, in another aspect, the quaternary ammonium biocide is a dialkyl dimethyl ammonium compound, an alkyl dimethyl benzyl ammonium compound, an alkyl trimethyl ammonium compound, or a combination thereof. For instance, in one aspect, the quaternary ammonium biocide is a C8 dialkyl dimethyl ammonium compound, a C10 dialkyl dimethyl ammonium compound, a C12-C16 alkyl dimethyl benzyl ammonium compound, a C8-C18 alkyl trimethyl ammonium compound, or a combination thereof.

In yet another aspect, the disinfectant composition can be a ready to use composition. In one such aspect, the quaternary ammonium biocide is present in the ready to use composition in an amount from about 0.01 wt. % to about 5 wt. % based upon the weight of the composition, such as from about 0.05 wt. % to about 4 wt. %, such as from about 0.1 to about 3 wt. %, or even from about 0.15 wt. % to about 2 wt. %. Additionally or alternatively, the film forming agent is present in the ready to use composition in an amount of about 0.1 to about 10 wt. %, such as about 0.5 wt. % to about 9.5 wt. %, such as from about 1 wt. % to about 9 wt. %.

Moreover, in an aspect, the disinfectant composition can be in a concentrated form. In one such aspect, the quaternary ammonium biocide is present in the concentrated composition in an amount from about 0.1 wt. % to about 30 wt. % based upon the weight of the composition, such as about 0.5 wt. % to about 25 wt. %, such as about 1 to about 20 wt. %, or even from about 1.5 wt. % to about 15 wt. %. Additionally or alternatively, in one aspect, the film forming agent is present in the concentrated composition in an amount from 0.1 wt. % to about 50 wt. % based upon the weight of the composition, such as about 0.5 wt. % to about 40 wt. %, such as about 1 to about 35 wt. %, or even from about 1.5% to about 32.5 wt. %.

In an aspect, the quaternary ammonium biocide, the toughening agent, or both, can be a quaternary ammonium carbonate, bicarbonate, halide, phosphate, sulfate, or a combination thereof.

Moreover, in one aspect, the disinfectant composition can include a chelating agent, a second surfactant, a pH adjusting agent, a drying agent, an aqueous carrier, or a combination thereof. In a particular aspect, the chelating agent is a C1-C10 carboxylic acid, preferably wherein the carboxylic acid is citric acid, sorbic acid, acetic acid, boric acid, formic acid, maleic acid, adipic acid, lactic acid, malic acid, malonic acid, glycolic acid, or mixtures thereof. Furthermore, in an aspect, the second surfactant is a zwitterionic surfactant, which can be, in one aspect, a cocamidopropyl betaine, a cocamidopropyl hydroxylsultaine, or a combination thereof.

Additionally or alternatively, in an aspect, the disinfectant composition does not include a film forming agent other than the polyethyleneimine.

The present disclosure is also generally directed to a method of providing residual sanitization to a hard surface. The method includes applying a disinfectant composition to a hard surface and subjecting the hard surface to an abrasion cycle using a GardCo Washability and Wear Tester set between 2.25 and 2.5, where the composition provides a Log Reduction of about 2 or greater against S. aureus after undergoing abrasion for at least two seconds. In addition, the disinfectant composition includes a quaternary ammonium biocide and a film forming agent that includes a polyethyleneimine.

In one aspect, the method exhibits the log reduction after the hard surface is subjected to two to twelve abrasion cycles of about 2 to about 5 seconds. Moreover, in one aspect, the composition further provides a Log Reduction of about 2 or greater against K. aerogenes.

Additionally or alternatively, in an aspect, the disinfectant composition applied to the surface further has a pH of greater than about 9, or even greater than about 9.5. In another aspect, the disinfectant composition applied to the surface further contains a nonionic surfactant. In one aspect, the hard surface to which the disinfectant composition is applied is a non-porous and/or inanimate surface.

In a further aspect, the disinfectant composition applied to the surface further includes a toughening agent, which, in one aspect, is a C12 to C24 fatty alkyl quaternary ammonium compound or a silane quaternary ammonium that is different from the quaternary ammonium biocide. In one such aspect, the toughening agent is a cetyl trimethyl ammonium compound, a lauryl trimethyl ammonium compound, a stearyldimethyl benzyl ammonium compound, a soyatrimethylammonium compound, a behentrimethylammonium compound, a dimethyl ditallow quaternary ammonium compound, or a combination thereof. Moreover, in an aspect, the quaternary ammonium biocide included in the disinfectant composition of the method is a dialkyl dimethyl ammonium compound, an alkyl dimethyl benzyl ammonium compound, an alkyl trimethyl ammonium compound, or a combination thereof. In one such aspect, the quaternary ammonium biocide is a C8 dialkyl dimethyl ammonium compound, a C10 dialkyl dimethyl ammonium compound, a C12-C16 alkyl dimethyl benzyl ammonium compound, a C8-C18 alkyl trimethyl ammonium compound, or a combination thereof.

Other features and aspects of the present disclosure are discussed in greater detail below, and it should be understood that any one or more of the above aspects can be utilized alone or in combination with any of the other aspects noted above or otherwise discussed herein.

### Definitions

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

Quaternary ammonium compounds, also known as “quats”, typically comprise at least one quaternary ammonium cation with an appropriate anion. Quats will generally have the general formula (1).

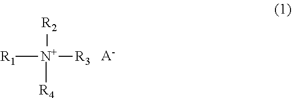

The groups R₁, R₂, R₃ and R₄ can vary within wide limits and examples of quaternary ammonium compounds that have anti-microbial properties will be well known to the person of ordinary skill in the art. Typically, one or more of R₁, R₂, R₃ and R₄ are lower alkyl, meaning having 1 to 4 carbon atoms, such as methyl, ethyl, propyl or butyl groups. In addition, one or more of R₁, R₂, R₃ and R₄ are longer chain alkyl groups of 6 to 24 carbon atoms, or a benzyl group. A⁻ is a monovalent anion or one equivalent of a polyvalent anion of an inorganic or organic acid. Suitable anions for A⁻ are in principle all inorganic or organic anions, in particular halides, for example chloride or bromide, carbonates, bicarbonates, carboxylates, sulfonates, phosphates or a mixture thereof. Carboxylates may be derived from lower carboxylic acids or from fatty acids.

Alkyl, hereinafter, is taken to mean in each case unbranched or branched alkyl groups of the specified number of carbons. In particular, this is also taken to mean the homologue mixtures derived from natural raw materials, for example “cocoalkyl”.

Substituted phenyl is taken to mean, in particular, phenyl groups substituted with one or more C₁₋₁₈ alkyl groups and/or halogen atoms.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to a composition for disinfecting surfaces that not only delivers fast, effective, anti-microbial properties over a broad spectrum of microorganisms, but also provide residual antimicrobial activity over an extended length of time. Namely, the present disclosure has surprisingly found that the combination of a quaternary ammonium biocide and a film forming agent that includes a polyethyleneimine forms a synergistic composition that not only provides good antimicrobial activity over a broad spectrum of microorganisms initially but also forms a coating or film over the surface providing antimicrobial properties over an extended length of time that is highly abrasion and touch resistant. Of particular advantage, the coating or film formed on the surface is clear, non-tacky, and relatively invisible.

For instance, the present disclosure has surprisingly found that a disinfectant composition according to the present disclosure can exhibit a log reduction of about 2 or greater against one or more microorganisms, as will be discussed in greater detail below, such as against S. aureus, K. aerogenes, or a combination thereof, even after undergoing abrasion resistance testing according to EPA 01-1A, such as a log reduction of about 2.5 or greater, such as a log reduction of about 3 or greater, such as a log reduction of about 3.5 or greater, or any ranges or values therebetween. Namely such effects were surprisingly exhibited even after about two abrasion cycles according to EPA 01-1A, such as about three abrasion cycles or more, such as about four abrasion cycles or more, such as about five abrasion cycles or more, such as about six abrasion cycles or more, such as about seven abrasion cycles or more, such as about eight abrasion cycles or more, such as about nine abrasion cycles or more, such as about ten abrasion cycles or more, such as about eleven abrasion cycles or more, up to about twelve abrasion cycles according to EPA 01-1A, or any ranges or values therebetween, where each abrasion cycle lasts from about 2 seconds to about 5 seconds. As known in the art, and as will be discussed in greater detail in the examples below, EPA protocol 01-1A requires a series of wet and dry abrasions and re-inoculations of the test substrate, that are extremely difficult to pass. Thus, according to the above, the disinfectant composition can exhibit the above log reduction on a surface for a period of about 1 hour or greater, such as about 2 hours or greater, such as about 4 hours or greater, such as bout 6 hours or greater, such as about 12 hours or greater, such as about 18 hours or greater, even up to about 24 hours. Therefore, as noted above it was surprising that the synergistic compositions of the pending claims were able to pass EPA 01-1A while exhibiting excellent anti-microbial activity.

Furthermore, after undergoing testing according to EPA 01-1A, an amount of disinfectant composition can remain on the surface even according to any one or more of the above cycles or time periods (displayed as Percent Weight Retention in the examples below), of about 5 wt. % or greater, such as about 7.5 wt. % or greater, such as about 8 wt. % or greater, such as about 10 wt. % or greater, such as about 12.5 wt. % or greater, up to about 95 wt. % or less, or any ranges or values therebetween, based upon the weight of the film or coating formed by the disinfectant composition prior to abrasion testing. Of course, as will be discussed in greater detail below, a greater amount of weight may be removed by wet testing than dry testing, however, the disinfectant composition discussed herein still provides an excellent abrasion and touch resistant coating, even when subjected to repeated wet abrasion conditions.

Nonetheless, examples of particular microorganisms that may be killed or controlled in accordance with the present disclosure, and which may exhibit the above log reductions before or after abrasion testing include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Enterobacter gergoviae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof.

Regardless of the microorganisms selected, in one aspect, the quaternary ammonium biocide includes a dialkyl dimethyl ammonium compound, an alkyl dimethyl benzyl ammonium compound, an alkyl trimethyl ammonium compound, or a combination thereof.

In one aspect, the dimethyl dialkyl ammonium compound may have between about 8 and about 12 carbon atoms, such as from about 8 to about 10 carbon atoms in each of the alkyl groups. Examples of dimethyl dialkyl ammonium compounds include dimethyl dioctyl ammonium compounds, dimethyl didecyl ammonium compounds, or combinations thereof.

Examples of an alkyl dimethyl benzyl ammonium compound can include quaternary ammonium compounds containing an alkyl group having from about 10 to about 18 carbon atoms, such as from about 12 to about 16 carbon atoms. For example, the quaternary ammonium biocide can be a C12 alkyl dimethyl benzyl ammonium compound, a C14 alkyl dimethyl benzyl ammonium compound, a C16 alkyl dimethyl benzyl ammonium compound, or combinations therefore.

Furthermore, examples of an alkyl trimethyl ammonium compound can include quaternary ammonium compounds containing an alkyl group having from about 8 to about 18 carbon atoms. For example, the quaternary ammonium biocide can be a C8 alkyl trimethyl ammonium compound, a C10 alkyl trimethyl ammonium compound, a C12 alkyl trimethyl ammonium compound, a C14 alkyl trimethyl ammonium compound, a C16 alkyl trimethyl ammonium compound, or combinations therefore.

However, while examples of the dialkyl dimethyl ammonium compound, the alkyl dimethyl benzyl ammonium compound, and the alkyl trimethyl ammonium compound were discussed separately, it should be understood that the quaternary ammonium biocide can include more than one specific quaternary ammonium compound and, in one aspect, includes a combination of any of the above described quaternary ammonium compounds.

As will be discussed in greater detail below, the disinfectant composition according to the pending claims can be formulated as a concentrated composition or diluted to a ready to use composition. When formulated as a concentrated composition, the quaternary ammonium biocide is present in the composition in an amount from about 0.1 wt. % to about 30 wt. % based upon the weight of the composition, such as about 0.5 wt. % to about 25 wt. %, such as about 1 to about 20 wt. %, such as about 1.5 wt. % to about 15 wt. %, or any ranges or values therebetween, based upon the weight of the disinfectant composition. When formulated as a ready to use composition, the quaternary ammonium biocide is present in the composition in an amount from about 0.01 wt. % to about 5 wt. % based upon the weight of the composition, such as about 0.05 wt. % to about 4 wt. %, such as about 0.1 to about 3 wt. %, such as from about 0.15 wt. % to about 2 wt. %, or any ranges or values therebetween, based upon the weight of the disinfectant composition.

Nonetheless, as noted above, the present disclosure has surprisingly found that a disinfectant composition having good anti-microbial properties and abrasion resistance can be formed utilizing the quaternary ammonium biocide in combination with a film forming agent that includes a polyethylenimine. In one aspect, the disinfectant can include a second film forming agent, such as a polyvinyl alcohol, a polyvinyl pyrrolidone, a silane, a siloxane, or a combination thereof, or the like. However, in one aspect, the synergistic properties of the polyethyleneimine and the quaternary ammonium biocide allow the formation of a disinfectant composition that is generally free of secondary film forming agent(s).

When formulated as a concentrated composition, the film forming agent is present in the composition in an amount from 0.1 wt. % to about 50 wt. % based upon the weight of the composition, such as about 0.5 wt. % to about 40 wt. %, such as about 1 to about 35 wt. %, such as from about 1.5% to about 32.5 wt. %, or any ranges therebetween, based upon the weight of the disinfectant composition. When formulated as a ready to use composition, the film forming agent is present in the composition in an amount of about 0.1 to about 10 wt. %, such as about 0.5 wt. % to about 9.5 wt. %, such as about 1 wt. % to about 9 wt. %, or any ranges or values therebetween, based upon the weight of the disinfectant composition.

Regardless of the amounts selected or whether the disinfectant composition is present as a concentrate or ready to use formulation, the disinfectant composition can include an amount of film forming agent that is greater than the amount of quaternary ammonium biocide, allowing the amount of biocide to be reduced. For instance, in one aspect, the ratio of an amount of film forming agent to an amount of quaternary ammonium biocide is at least about 1.1:1 or greater, such as about 1.25:1 or greater, such as about 1.5:1 or greater, such as about 1.75:1 or greater, such as about 2:1 or greater, such as about 2.5:1 or greater, such as about 3:1 or greater, up to about 20:1 or less, or any ranges or values therebetween.

Moreover, the present disclosure has also surprisingly found that the above anti-microbial properties and abrasion resistance can be exhibited or even improved when the composition has a relatively high pH, such as about 9 or greater, such as about 9.25 or greater, such as about 9.5 or greater, such as about 9.75 or greater, such as about 10 or greater, such as about 10.25 or greater, or any ranges or values therebetween. Namely, without wishing to be bound by theory, it is believed that the polyethyleneimines can exhibit a lower solubility at higher pH values while remaining stable in the composition, allowing a more robust film to be formed.

Furthermore, the disinfectant composition according to the present disclosure can also include a nonionic surfactant, which, can, in one aspect, improve the spreadability and/or wetting of the disinfectant composition, allowing a more even film with improved abrasion resistance to be formed. When present in the composition, the nonionic surfactant can be an alkoxylated alcohol, a polyoxyethylene glycol alkyl ether, an octaethylene glycol monododecyl ether, a pentaethylene glycol monododecyl ether, a polyoxypropylene glycol alkyl ether, an alkyl polyglucoside, glucoside alkyl ethers, decyl glucoside, lauryl glucoside, octyl glucoside, a polyoxyethylene glycol octylphenol ether, a polyoxyethylene glycol alkylphenol ether, a glycerol alkyl ester, a polyglycerol ester, glyceryl laurate, a polyoxyethylene glycol sorbitan alkyl ester, a sorbitan alkyl ester, dodecyldimethylamine oxide, block copolymers of polyethylene glycol and polypropylene glycol, poloxamers and polyethoxylated tallow amine (POEA), and mixtures thereof. Nonetheless, in one aspect, the nonionic surfactant is an alkyl polyglucoside, an alcohol polyglycol ether, an amine ethoxylate, a fatty alcohol alkoxylate, a polyethylene glycol, an alcohol PEG-ether, a fatty acid ethoxylate, a glycerol ester, or combinations thereof. Moreover, in an aspect, the nonionic surfactant is an alkyl polyglucoside.

The amount of the nonionic surfactant in the ready to use composition can be from about 0.01% to about 5% based on weight of the composition, such as about 0.05% to about 3% of nonionic surfactant, such as about 0.1% to about 1.5%, or any ranges or values therebetween. When present in a concentrated formulation, the nonionic surfactant can be present in the disinfectant composition in an amount from about 0.1% to about 10%, such as about 0.5 to about 7.5%, such as about 1% to about 5%, or any ranges or values therebetween, based upon the weight of the disinfectant composition.

Regardless of the amounts selected or whether the disinfectant composition is present as a concentrate or ready to use formulation, when present, the film forming agent can be present in an amount greater that an amount of nonionic surfactant. For instance, in one aspect, the ratio of an amount of film forming agent to an amount of nonionic surfactant is at least about 1.1:1 or greater, such as about 1.25:1 or greater, such as about 1.5:1 or greater, such as about 1.75:1 or greater, such as about 2:1 or greater, such as about 2.5:1 or greater, such as about 3:1 or greater, such as about 4:1 or greater, up to about 50:1 or less, such as about 40:1 or less, such as bout 30:1 or less, or any values or ranges therebetween.

Moreover, in one aspect, the disinfectant composition can also include a toughening agent, which can, in some instances, provide further abrasion resistance to the disinfectant composition. Thus, in one aspect, the disinfectant can also include a toughening agent, where the toughening agent is a C12 to C24 fatty alkyl quaternary ammonium compound or a silane quaternary ammonium that is different from the quaternary ammonium biocide, such as, in one aspect, a cetyl trimethyl ammonium compound, a lauryl trimethyl ammonium compound, a stearyldimethyl benzyl ammonium compound, a soyatrimethylammonium compound, a behentrimethylammonium compound, a dimethyl ditallow quaternary ammonium compound (and/or di(partially hydrogenated tallow) dimethylammonium compound, tricetyl methyl ammonium chloride, or a combination thereof.

When formulated as a concentrated composition, the toughening agent can be present in the composition in an amount from about 0.1 wt. % to about 30 wt. % based upon the weight of the composition, such as about 0.5 wt. % to about 25 wt. %, such as about 1 to about 20 wt. %, such as about 1.5 wt. % to about 15 wt. %, or any ranges or values therebetween, based upon the weight of the disinfectant composition. When formulated as a ready to use composition, the toughening agent is present in the composition in an amount from about 0.01 wt. % to about 5 wt. % based upon the weight of the composition, such as about 0.05 wt. % to about 4 wt. %, such as about 0.1 to about 3 wt. %, such as from about 0.15 wt. % to about 2 wt. %, or any ranges or values therebetween, based upon the weight of the disinfectant composition

Regardless of the toughening agent selected, if any, the quaternary ammonium compounds contained in the disinfectant composition, such as the quaternary ammonium biocide, the toughening agent, or a combination thereof, are a quaternary ammonium carbonate, bicarbonate, halide, phosphate, sulfate, or a combination thereof.

Additionally or alternatively, the disinfectant composition can further include a second surfactant. In one aspect, the second surfactant can be a zwitterionic surfactant, such as a betaine surfactant. The betaine surfactant can be a betaine or sulfobetaine surfactant. The betaine surfactant can include betaines and sulfobetaines of the formula (2)

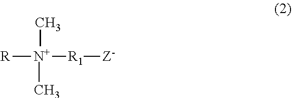

wherein R is alkyl or (3)

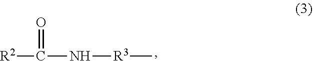

Z⁻ is COO⁻ or SO₃⁻, R₁ is alkyl or hydroalkyl, R₂ is alkyl of up to about 20 carbon atoms, preferably about 6 to about 16 carbon atoms, and R₃ is alkyl.

Moreover, the betaine surfactant can have the following formula:

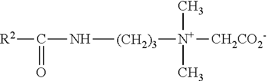

Wherein R² comprises an alkyl group having up to about 20 carbon atoms, such as from about 6 carbon atoms to about 16 carbon atoms.

Examples of betaines useful herein include decyl betaine or 2-(N-decyl-N,N-dimethylammonio) acetate, myristyl betaine, palmityl betaine, lauryl betaine, cetyl betaine, stearyl betaine, coco dimethyl carboxymethyl betaine (“cocobetaine”), cocoamidoethyl betaine, cocoamidopropyl betaine, lauramidopropyl betaine, myristyl amidopropyl betaine, lauryl dimethyl carboxymethyl betaine, lauryl dimethyl alpha-carboxy-ethyl betaine, cetyl dimethylcarboxymethyl betaine, lauryl bis-(2-hydroxy-ethyl) carboxy methyl betaine, stearyl bis-(2-hydroxy-propyl) carboxymethylbetaine, oleyl dimethyl gamma-carboxypropyl betaine, lauryl bis-(2-hydroxypropyl) alpha-carboxyethyl betaine, cocoamidopropyl dimethyl betaine, and mixtures thereof and the like.

Examples of sulfobetaine surfactants include 3-(N,N-dimethyl-N-acylamidopropylammonio)-2-hydroxy-propane-1-sulfonates, wherein the acyl group is derived from tallow fatty alcohol or coconut fatty alcohol, with coconut fatty alcohol preferred. It will be recognized by those skilled in the art that, in the normal preparation of these derivatives of tallow or coconut fatty alcohols, a mixture of sulfobetaines with varying carbon chain lengths for the acyl groups will result. These fatty alcohols contain, for the most part, carbon chain lengths that will provide acyl groups with the desired number of carbon atoms, i.e., from about 8 to about 18 carbon atoms. Thus, these mixtures obtained from tallow or coconut fatty alcohols are useful in providing the sulfobetaine surfactant for reagents of the present disclosure. A material of this type for use in compositions of the present disclosure is N-cocoamido-propyl-N,N-dimethyl-N-2-hydroxypropyl sulfobetaine. An example of this is LONZAINE CS, which is commercially available from Lonza, Inc.

The betaine may also comprise a betaine polymer, such as an amphiphilic betaine polymer. The polymeric betaine, for instance, may comprise a complex of a dialkyl disalkoxylated quaternary ammonium salt with boric acid. Other similar compounds may also include quaternary amine salts formed by the protonation of monoalkylamines, dialkylamines, trialkylamines and monobisalkoxylated amines. In one particular embodiment, the polymeric betaine may comprise didecyl bis(hydroxyethyl) ammonium borate. The polymeric betaine may have the following formula:

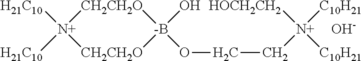

Nonetheless, in one aspect, the zwitterionic surfactant is a betaine surfactant, such as a cocamidopropyl betaine, a cocamidopropyl hydroxylsultaine, or a combination thereof. The disinfectant composition of the present disclosure may contain a single betaine as described above or a combination of betaines as all of part of the zwitterionic surfactant.

The disinfectant composition according to the present disclosure can also include a chelating agent. Namely, without wishing to be bound by theory, it is believed that chelating agents, such as carboxylic acid chelating agents, may provide complexes with the quaternary ammonium biocide at high pH levels, further stabilizing the composition. Thus, while, in one aspect, any chelating agent as known in the art may be suitable, such as ethylene diamine tetra acetic acid (EDTA) and salts thereof (e.g., tetrasodium EDTA), diammonium ethylene diamine tetraacetate, aminocarboxylic acids, amino phosphonic acids, fatty acid salts, mixtures thereof, and the like, in a further aspect, the chelating agent is a C1-C10 carboxylic acid. Thus, in one aspect, the chelating agent is citric acid, sorbic acid, acetic acid, boric acid, formic acid, maleic acid, adipic acid, lactic acid, malic acid, malonic acid, glycolic acid, or mixtures thereof. The chelating agent can be present in the ready to use composition in an amount of from about 0.01% to about 10%, such as from about 0.05% to about 6%, such as about 0.1% to about 5% based on weight of the composition, or any ranges or values therebetween. In addition, the chelating agent can be present in a concentrated formulation in an amount from about 0.1% to about 20%, such as about 0.5% to about 15%, such as about 1% to about 10%, or any ranges or values therebetween.

The composition may further contain additional ingredients, including solvents, a pH adjusting agent, a drying agent, an aqueous carrier, dyes, fragrances, preservatives, and the like. Each of the additives can be present alone or in combination with other additives.

For instance, the antimicrobial composition may also contain a pH builder. Suitable pH builders include sodium hydroxide, potassium hydroxide, potassium carbonate, sodium citrate, sodium carbonate, silicates such as sodium metasilicate, an alkanolamine, and other similar compounds. In one aspect, the pH builder is a sodium metasilicate pentahydrate, monoethanolamine, or a combination thereof. The pH builder can be present in the ready to use composition in an amount from about 0.01% to about 2%, such as from about 0.02% to about 1%, or any ranges or values therebetween, based on weight of the composition.

As discussed above, the disinfectant composition of the present disclosure can be supplied as a concentrate, which is diluted to use levels prior to use. Alternatively, the disinfecting composition can be provided as a ready-to-use (RTU) composition. In either case, the composition contains a solvent.

Generally, the solvent will be a polar solvent such as water, or an organic solvent, such as an alcohol and/or a glycol ether. In one embodiment, the only solvent present in the composition is water. Alternatively, the composition may contain water in combination with an organic solvent.

Examples of organic solvents include ethanol, propanol, benzyl alcohol, phenoxyethanol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol n-butyl ether, ethylene glycol dimethyl ether, ethylene glycol diethyl ether, ethylene glycol dibutyl ether, propylene glycol n-butyl ether, propylene glycol n-propyl ether, tripropylene glycol methyl ether, dipropylene glycol methyl ether, dipropylene glycol butyl ether, dipropylene glycol n-propyl ether, ethylene glycol hexyl ether and combinations thereof.

Water can be present in the ready to use composition generally in an amount greater than about 60% by weight, such as greater than about 70% by weight, such as greater than about 80% by weight, such as greater than about 90% by weight. For example, water can be present in the composition in an amount greater than about 92% by weight, such as in an amount greater than about 94% by weight, such as in an amount greater than about 96% by weight, such as in an amount greater than about 98% by weight. Water is generally present in an amount less than about 99.5% by weight, such in an amount less than about 99% by weight, such in an amount less than about 95% by weight, or any ranges or values therebetween. However, water can also be present in the concentrated formulation, such as in an amount of about 85% or less, such as about 75% or less, such as about 65% or less, such as about 60% or less, or such as from about 2.5% to about 95%, such as from about 3% to about 90%, such as from about 5% to about 85%, or any ranges or values therebetween, based upon the weight of the disinfectant composition.

In one aspect, the solvent comprises water and an additional organic solvent such as isopropanol, propylene glycol n-propyl ether, or propylene glycol n-butyl ether. When a solvent is present in addition to water, it is preferably present in the concentrate in an amount from about 0.1% to about 20% based on weight of the composition, such as about 0.25% to about 15%, such as about 0.5% to about 10% by weight, or any ranges or values therebetween. In a ready to use composition, the organic solvent in addition to water can be present in an amount from about 0.01% to about 2%, such as from about 0.05% to about 1.5%, such as from about 0.1% to about 1%, such as about 0.25% to about 0.75% based on weight of the composition.

The disinfectant composition of the present disclosure may optionally further contain corrosion inhibitors, auxiliaries, preservatives, fragrances, colorants and the like. Exemplary corrosion inhibitors include, for example, organic phosphorous compounds and blend of organic phosphorous compounds with a polymeric component. Colorants and fragrances may be added provided they do not interfere with the function of the composition and may serve for identifying the composition. Generally, the optional further ingredients will make up less than about 20% by weight of the composition. For example, each of the above identified ingredients or components can be present in the ready to use or concentrated composition generally in an amount from about 0.01% by weight to about 5% by weight. For instance, each of the above components can be present in the composition in an amount from about 0.1% to about 2% by weight, such as from about 0.3% to about 1% by weight, or any ranges or values therebetween. The optional additives are added in amounts conventionally used in sanitizing and disinfecting compositions.

Advantageously, it has been found that the addition of fragrance does not change the streaking and filming performance of the composition.

Nonetheless, the present disclosure is also generally directed to providing residual sanitization to a hard surface and/or to clean and/or sterilize instruments. Thus, in one aspect, the disinfectant composition can be delivered to a surface to be cleaned, sanitized or disinfected by conventional methods, such as pouring the composition on a surface; spraying the surface, including but not limited to, pump spray applicators, pressurized spray applicators and the like; a saturated wipe; a rag and a bucket; a mop and bucket; a sponge and a bucket; or via automated cleaning equipment and other similar and conventional ways to apply an anti-microbial or disinfectant composition to a surface for the purposes of sanitizing or disinfecting the surface.

To use the disinfectant composition of the present disclosure, a surface is treated with the substrate by spraying, pouring, wiping, or otherwise applying the anti-microbial composition to the surface. Once applied to the surface, the disinfectant composition is allowed to remain on the surface for a period of time. The disinfectant composition may be applied to the surface and allowed to dry or may alternatively be dried by wiping the surface with a dry wipe or wiping device.

Surfaces, which may be disinfected with the disinfectant composition include, but are not limited to, those located in dairies, homes, health care facilities, swimming pools, canneries, food processing plants, restaurants, hospitals, institutions, and industry, including secondary oil recovery. Any suitable hard surface may be treated in accordance with the present disclosure, particularly frequently touched hard surfaces. The hard surface, for instance, can be made from glass, a metal such as an aluminum or stainless steel, a ceramic, a stone such as granite or marble, a plastic or polymer material, or the like. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions are particularly well suited for application on indirect food contact surfaces, such as cutting boards, utensils, containers, dishes, wash basins, appliances, and countertops. Areas in hospitals would include beds, gurneys, tables, canisters, toilets, waste cans, stands, cabinets, shower stalls, floors, door knobs, bed rails, walls or any other non-porous surface. Particularly, in one aspect, the surface can be an inanimate, non-porous, hard surface in any location.

One particularly useful application method is to impregnate the disinfectant composition into a wipe substrate. In such an aspect, the wipe can be a single use wipe that is impregnated with the disinfecting composition and is stored in a container that will dispense the wipe to a user. The container with the wipes may contain a single wipe, or several wipes. Suitable containers include a pouch containing a single wipe, such as a moist towelette which is torn open by the user, or may be a pouch with a resealable opening containing several wipes in a stacked fashion, a rolled fashion or other suitable formation that would allow a single wipe to be removed from the opening at a time. Pouches are generally prepared from a fluid impervious material, such as a film, a coated paper or foil or other similar fluid impervious materials. Another way to dispense wipes of the present disclosure is to place the wipe in to a fluid impervious container having an opening to access the wipes in the container. Containers may be molded plastic containers with lids that are fluid impervious. Generally, the lid will have an opening to access the wipes in the container. The wipe in the container may be in a interleaved stacked, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

The disinfecting composition can be impregnated into the wipe such that the wipe is pre-moistened and will express or release the disinfecting composition onto the surface as the wipe is run across the surface to be treated. Generally, the disinfecting composition is saturated into the wipe such that the wipe will release the disinfecting composition onto the surface through the wiping action. Depending on the wipe substrate, saturation is generally achieved using about 3 wt parts of the disinfecting composition per 1 wt part of the wipe substrate to be saturated. Generally, the disinfecting composition is used from about 4 parts to 6 parts by weight per 1 part by weight of the wiper substrate. In these ranges, complete saturation of the substrates can be achieved. It is noted that the amount of the disinfecting solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

The following examples are intended to provide a more complete understanding of the present invention. The examples are not intended, however, to limit the invention.

### Examples

### Test Methods and Conditions

### Test Conditions

Organisms: S. aureus ATCC 6538
   K. aerogenes ATCC 13048
Culture Media: Nutrient broth was used for test cultures for S. aureus
Tryptic Soy Broth was used for test cultures of K. aerogenes
Organic Soil: 5% Fetal Bovine Serum (FBS)
Dilution: Ready to use
Temperature: 20° C.
Residual Time: 24 Hours
Contact time (Sanitizer test): 5 minutes
Neutralizer: D/E Broth
Carriers: 1″×1″ glass microscope slide, decontaminated by immersing in ethanol and allowed to dry.
Product Application: Products were applied by spraying the test surface for 2 seconds at 6-8 inches distance
Abrasion Speed: 2.0 to 2.5 for total surface contact time of approximately 5 seconds per abrasion cycle
Inoculation Process: Inoculations performed using a 10 μl micropipette, with at least three consecutive daily transfers with incubation at 35+2° C., according to EPA #01-1A.

### Test Methods

For the Micro Efficacy testing (shown as Log Reduction in Table 1), were conducted according to EPA Protocol #01-1A (2022). Namely, glass slide carriers as discussed above were applied with a 10 μL aliquot of an initial inoculation (48-54 hour culture, serially diluted by two 0.1 mL to 9.9 mL serial dilutions), and allowed to dry uncovered at 35+2° C. until visibly dry. The respective sample was then applied to the carrier, and allowed to dry.

The dried samples were then subjected to abrasion testing at a speed of 2.0 to 2.5 for total surface contact time of approximately 5 seconds per abrasion cycle (each cycle includes a first pass and return pass). The carriers are then subjected to a wear and reinoculation regime for 24 hours at room temperature and 45-55% relative humidity, by repeating the above initial inoculation, where the 24-hour reinoculations were prepared by, vortex an 18-24 hour culture, making two 0.1 mL to 9.9 mL serial dilutions and one final dilution of 5.0 mL to 5.0 in sterile distilled water. In addition, a volume of serum to equal 5% organic soil load was added to the dilution, applied to the carrier, and allowed to dry until visibly dry (at least 30 minutes).

For each cycle, wet-wear and dry-wear were alternated, for a total of six wet-wear and six dry-wear cycles, wet-wear cycles were conducted by spraying the cloth with sterile distilled water as specified in EPA 01-1A. After the twelfth cycle, log reduction of organisms surviving on the carriers was determined and recorded as shown in Table 1.

For the abrasion screening data of samples 1 to 6 (shown as weight retention in Table 1), the test procedure above was modified by utilizing only the inoculum media without live cultures present, where the weight retention was determined based upon the remaining quaternary ammonium biocide(s) as compared to an initial amount of quaternary ammonium biocide(s) via a liquid-chromatography, mass spectrometry (LC-MS) method.

Additionally, samples 9-15 were formed as discussed in regards to the abrasion screening of samples 1 to 6, except that all twelve cycles were wet-wear cycles, where the weight retention was determined based upon the weight loss of the film on the glass carrier compared to the initial weight after allowing the sample to dry overnight.

Formulation details for the disinfectant samples are provided in Table 1 where water was used to 100% to form the ready to use compositions. Anti-microbial activity after abrasion resistance testing data is also provided in Table 1 using the test methods and conditions noted above. As shown in Table 1, compositions according to the present disclosure exhibited excellent anti-microbial activity even after vigorous abrasion testing.

TABLE 1

| Ingredient/Sample | 1 | 2 | 3 | 4 | 5 | 6 | 7 | 8 |
|---|---|---|---|---|---|---|---|---|
| Polyethyleneimine | 3.00 | 3.00 | 3.00 | 3.00 | 4.00 | 3.00 | 3.00* | 3.00* |
| Quaternary ammonium | 0.40 | 0.20 | 0.50 | 0.30 | 0.50 | 0.40 | 0.50 | 0.40 |
| biocide¹ | | | | | | | | |
| Quaternary ammonium | | | | | | | | |
| biocide² | | | | | | | | |
| Toughening agent³ | | 0.25 | | 0.25 | | 0.30 | | 0.30 |
| Citric Acid | 0.25 | | 0.25 | 0.25 | 0.25 | 0.25 | 0.25 | 0.25 |
| Lactic Acid | | | | | | | | |
| alkyl poly glucoside | | | | | | | 0.20 | 0.20 |
| pH | 11.50 | 11.50 | 10.45 | 10.49 | 10.25 | 10.50 | 10.53 | 10.50 |
| Log Reduction | | | | | | | | |
| K. aerogenes | NT | NT | 3.8 | 3.1 | 4.39 | 2.04 | 2.84 | 2.38 |
| St. Dev. | | | 0.3 | 1.15 | 1.55 | 0.88 | 1.61 | 1.69 |
| Lowest replicate | | | 3.41 | 2.25 | 2.65 | 0.99 | 1.56 | 0.76 |
| S. aureus | 2.21 | 2.61 | 2.52 | ≥3.82 | ≥4.83 | ≥4.75 | NT | NT |
| St. Dev. | 2.45 | 2.46 | 1.79 | 1.18 | 0 | 0.15 | | |
| Lowest replicate | 0.08 | 0.17 | 0.09 | 2.04 | 4.83 | 4.53 | | |
| Weight Retention | | | | | | | | |
| 4 cycles | 65.8 | 60.4 | 74.4 | 93.1 | 67.2 | 48.3 | | |
| 8 cycles | 54.4 | 52.2 | 60.7 | 66.5 | 33.8 | 24.1 | | |
| 12 cycles | 54.4 | 53.7 | 51.5 | 64.6 | 18.4 | 11.7 | | |
| | Ingredient/Sample | 9 | 10 | 11 | 12 | 13 | 14 | 15 |
| | Polyethyleneimine | 4.00 | 4.00 | 3.00 | 3.00 | 2.00 | 1.00 | |
| | Quaternary ammonium | 0.50 | | 0.50 | 0.50 | 0.50 | 0.50 | 0.50 |
| | biocide¹ | | | | | | | |
| | Quaternary ammonium | | 0.50 | | | | | |
| | biocide² | | | | | | | |
| | Toughening agent³ | | | | | | | |
| | Citric Acid | 0.25 | | 0.25 | | | | |
| | Lactic Acid | | 0.35 | | | | | |
| | alkyl poly glucoside | 0.50 | 0.20 | 0.50 | 0.50 | 0.50 | 0.50 | 0.50 |
| | pH | 10.16 | 10.48 | 10.26 | 10.50 | 10.55 | 10.59 | 10.47 |
| | Log Reduction | | | | | | | |
| | K. aerogenes | ≥4.15 | 2.10 | 4.40 | ≥4.95 | 2.88 | 2.85 | NT |
| | St. Dev. | 0.86 | 0.58 | 0.43 | 0 | 1.10 | 1.32 | |
| | Lowest replicate | 3.01 | 1.72 | 3.95 | 4.95 | 1.88 | 1.52 | |
| | S. aureus | ≥5.33 | NT | ≥4.77 | ≥4.77 | NT | NT | NT |
| | St. Dev. | 0 | | 0 | 0 | | | |
| | Lowest replicate | ≥5.33 | | ≥4.77 | ≥4.77 | | | |
| | Weight Retention | | | | | | | |
| | 4 cycles | 36.8 | 29.2 | 61.1 | 34.5 | 41.5 | 50.0 | 33.3 |
| | 8 cycles | 23.7 | 20.8 | 38.7 | 29.1 | 34.1 | 38.5 | 25.0 |
| | 12 cycles | 14.5 | 8.3 | 20.6 | 27.3 | 31.7 | 30.8 | 16.7 |

¹Blend of dioctyl dimethyl ammonium chloride, didecyl dimethyl ammonium chloride, and C12-C16 alkyldimethylbenzyl ammonium chlorides
²Blend of didecyl dimethyl ammonium carbonate and didecyl dimethyl ammonium bicarbonate
³Cetyl trimethyl ammonium chloride, 29% solids
*High Molecular wt PEI
NT = Not tested
Data for Samples 1-6 is residual data following the EPA 01-1A method, except using inoculum media with no live culture.
Data for samples 9-15 residual data following the EPA 01-1A method, except using inoculum media with no live cultures and using only wet-wear cycles.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A composition for providing hard surfaces with residual anti-microbial activity comprising:
a quaternary ammonium biocide;
a film forming agent comprising a polyethyleneimine; and
wherein the composition provides a Log Reduction of about 2 or greater against S. aureus after undergoing abrasion resistance testing according to EPA 01-1A.

2. The composition of claim 1, wherein the composition has a pH of about 9 or greater.

3. The composition of claim 1, further comprising a nonionic surfactant.

4. The composition of claim 1, further comprising a toughening agent comprising a C₁₂ to C₂₄ fatty alkyl quaternary ammonium compound or a silane quaternary ammonium that is different from the quaternary ammonium biocide, or a combination thereof.

5. The composition of claim 1, wherein the quaternary ammonium biocide is a dialkyl dimethyl ammonium compound, an alkyl dimethyl benzyl ammonium compound, an alkyl trimethyl ammonium compound, or a combination thereof.

6. The composition of claim 1, wherein the composition is a ready to use composition, wherein the quaternary ammonium biocide is present in the composition in an amount from about 0.01 wt. % to about 5 wt. % based upon the weight of the composition.

7. The composition of claim 1, wherein the composition is a ready to use composition, wherein the film forming agent is present in the composition in an amount of about 0.1 to about 10 wt. %.

8. The composition of claim 1, wherein the composition is a concentrated composition, wherein the quaternary ammonium biocide is present in the composition in an amount from about 0.1 wt. % to about 50 wt. % based upon the weight of the composition.

9. The composition of claim 1, wherein the composition is a concentrated composition, wherein the film forming agent is present in the composition in an amount from 0.1 wt. % to about 50 wt. % based upon the weight of the composition.

10. The composition of claim 1, wherein the quaternary ammonium biocide, the toughening agent, or both, are a quaternary ammonium carbonate, bicarbonate, halide, phosphate, sulfate, or a combination thereof.

11. The composition of claim 1, further comprising a chelating agent.

12. The composition of claim 8, wherein the chelating agent is a C₁-C₁₀ carboxylic acid, wherein the carboxylic acid is selected from e group consisting of citric acid, sorbic acid, acetic acid, boric acid, formic acid, maleic acid, adipic acid, lactic acid, malic acid, malonic acid, glycolic acid, and mixtures thereof.

13. The composition of claim 1, wherein the composition does not include a film forming agent other than the polyethyleneimine.

14. The composition of claim 1, further comprising a second surfactant, a pH adjusting agent, a drying agent, an aqueous carrier, or a combination thereof.

15. The composition of claim 1, wherein the nonionic surfactant comprises an alkyl polyglucoside, an alcohol polyglycol ether, an amine ethoxylate, a fatty alcohol alkoxylate, a polyethylene glycol, an alcohol PEG-ether, a fatty acid ethoxylate, a glycerol ester, or combinations thereof.

16. The composition of claim 1, wherein the second surfactant comprises a zwitterionic surfactant.

17. A method of providing residual sanitization to a hard surface comprising:
applying a composition to the hard surface, the composition comprising
a quaternary ammonium biocide;
a film forming agent comprising a polyethyleneimine;
subjecting the hard surface to an abrasion cycle using a GardCo Washability and Wear Tester set between 2.25 and 2.5, and
wherein the composition provides a Log Reduction of about 2 or greater against S. aureus after undergoing abrasion for at least two seconds.

18. The method of claim 17, wherein the composition has a pH of about 9 or greater.

19. The method of claim 17, wherein Log Reduction is exhibited after the hard surface is subjected to two to twelve abrasion cycles of about 2 to about 5 seconds.

20. The method of claim 17, wherein the composition further provides a Log Reduction of about 2 or greater against K. aerogenes.

21. The method of claim 17, wherein the hard surface is non-porous an inanimate, surface, or a non-porous and inanimate surface.

22. The method of claim 17, wherein the composition further comprises a nonionic surfactant.

23. The method of claim 17, wherein the composition further comprises a toughening agent selected from the group consisting of a cetyl trimethyl ammonium compound, a lauryl trimethyl ammonium compound, a stearyldimethyl benzyl ammonium compound, a soyatrimethylammonium compound, a behentrimethylammonium compound, a dimethyl ditallow quaternary ammonium compound, and a combination thereof.

24. The method of claim 17, wherein the quaternary ammonium biocide is selected from the group consisting of a C₈ dialkyl dimethyl ammonium compound, a C₁₀ dialkyl dimethyl ammonium compound, a C₁₂-C₁₆ alkyl dimethyl benzyl ammonium compound, a C₂-C₁₆ alkyl trimethyl ammonium compound, a C₈-C₁₈ alkyl trimethyl ammonium compound, and a combination thereof.
